(19) United States
(12) Patent Application Publication
(10) Pub. No.: US 2002/0162026 A1
(43) Pub. Date: Oct. 31, 2002

(54) Apparatus and method for providing secure network communication

(76) Inventors: Michael Neuman, Albuquerque, NM (US); Diana Neuman, Albuquerque, NM (US)

Correspondence Address: Roberts Abokhair & Mardula, LLC, Suite 1000, 11800 Sunrise Valley Drive, Reston, VA, 20191-5302, US

(21) Appl. No.: 10/068,776

(22) Filed: Feb. 6, 2002

Related U.S. Application Data
(60) Provisional application No. 60/266,626, filed on Feb. 6, 2001.

(51) Int. Cl. H04L 9/00

(52) U.S. Cl. 713/201; 713/150

(57) ABSTRACT

The present invention is drawn to an apparatus and method for providing secure network communication. Each node or computer on the network has a secure, intelligent network interface with a coprocessor that handles all network communication. The intelligent network interface can be built into a network interface card (NIC) or be a separate box between each machine and the network. The intelligent network interface encrypts outgoing packets and decrypts incoming packets from the network based on a key and algorithm managed by a centralized management console (CMC) on the network. The intelligent network interface can also be configured by the CMC with dynamically distributed code to perform authentication functions, protocol translations, single sign-on functions, multi-level firewall functions, distinguished-name based firewall functions, centralized user management functions, machine diagnostics, proxy functions, fault tolerance functions, centralized patching functions, Web-filtering functions, virus-scanning functions, auditing functions, and gateway intrusion detection functions.

### RELATIONSHIP TO OTHER APPLICATIONS

This application claims the benefit of U.S. Provisional Application No. 60/266,626, filed Feb. 6, 2001.

### FIELD OF THE INVENTION

The present invention is drawn to an apparatus and method for providing secure network communication. Each node or computer on the network has a secure, intelligent network interface with a coprocessor that handles all network communication. The intelligent network interface can be built into a network interface card (NIC) or be a separate box between each machine and the network. The intelligent network interface encrypts outgoing packets and decrypts incoming packets from the network based on a key and algorithm managed by a centralized management console (CMC) on the network. The intelligent network interface can also be configured by the CMC with dynamically distributed code to perform authentication functions, protocol translations, single sign-on functions, multi-level firewall functions, distinguished-name based firewall functions, centralized user management functions, machine diagnostics, proxy functions, fault tolerance functions, centralized patching functions, Web-filtering functions, virus-scanning functions, auditing functions, and gateway intrusion detection functions.

### BACKGROUND INFORMATION

The quest to protect data on a network from nosy employees or malicious hackers has spawned the multi-million dollar SmartCard industry. While providing one-time passwords protects an account from being logged into by a nosy insider, it does not necessarily protect all of the data that user accesses. Because the data is not encrypted, it is freely accessible to anyone who cares to look. While a number of commercial solutions are available to address this problem (Kerberos, Secure Shell (SSH), and DCE), none of these are widely ported, easy to use, or transparent to the user/application.

By design, computers and networks are not intended for security, but rather as a means to easily access and distribute information. Security solutions have always been an add-on to the network infrastructure, with security implementation arriving after the development of many of the applications and platforms we use today. This tacked-on or single-layer approach to administering security has consistently resulted in products that are cumbersome, restrictive, and largely ineffective. System administrators and corporate management have come to accept the quick fix approach of current security solutions. In effect, the approach is to incorporate a variety of security solutions with the best hope being that these measures will slightly lessen attacks or intrusion. Since systems are vulnerable to attack—incorporate an Intrusion Detection System (IDS). Since networks are vulnerable to outside infiltration—put a firewall in place. These security measures do offer a certain level of protection, but once the perpetrator has infiltrated this single point-of-access, they now have virtually unlimited access to the network and its contents. Furthermore, it is estimated that 70% of all intruders are insiders to the company and already have access to the network; gaining further unauthorized access is often a nominal achievement to the perpetrator.

U.S. Pat. 6,151,679 to Friedman et al. discloses a network security device that is self-configuring and locks itself to the IP address of its client. The security device translates the MAC address of the client to its own MAC address before transmitting packets onto the network. The system is primarily designed to prevent spoofing and lacks the functionality of a centrally administered system that does not tie security to an IP address or a MAC address.

U.S. Pat. 5,983,350 to Minear et al. discloses a system and method for regulating the flow of messages through a firewall. This system relies on a security association database stored within the firewall to allow encrypted communications over open networks. As such, this system has limited utility and is essentially for firewalling.

U.S. Pat. 6,038,233 to Hamamoto et al. discloses a translator for coupling a first network, such as an IPv4 network, to a second network, such as an IPv6 network. Likewise, U.S. Pat. 5,623,601 to Vu discloses and apparatus and method for providing a secure gateway for communication and data exchange between networks. Both of these systems have limited functionality as network interface proxies.

U.S. Pat. 6,003,084 to Green et al. discloses a secure network proxy for connecting different entities. The proxy is part of firewall program and controls exchanges of information between two application entities in accordance with find authentication procedures.

U.S. Pat. 5,781,550 to Templin et al. discloses a transparent and secure network gateway. The gateway, according rules stored in a configuration database, intercepts packets and acts as a proxy with untrusted computers.

What is needed is a single system to that can handle security threats from both outside and inside a network, that is easily configurable on a user basis, and that doesn't use computational resources of the client machines.

### BRIEF SUMMARY OF THE INVENTION

The present invention is drawn to a secure, intelligent network interface that is small enough and cheap enough to be equipped on every computer on a network. All traffic on that network is encrypted with a key known only to a user's secure, intelligent network interface and to a centralized management console (CMC). The optimal size for a key is dependant on the user's network, but 128-bit is typical. The secure, intelligent network interface can change the key size per connection, per host, per network, etc. and it can also change the algorithm used for each of those levels. In this manner, it is no longer necessary to swap cards when the entire network needs to be upgraded to a new encryption algorithm.

If a user taps directly into the network (bypassing the secure, intelligent network interface), all that will be seen is encrypted traffic. The secure, intelligent network interface automatically filters out all traffic not destined for (or originating from) the host behind the interface. All valid traffic is transparently decrypted and provided to the host's NIC or CPU. This enforces the validity of packets so that spoofing is no longer a possibility. It also enforces the security of all traffic on the network. It is completely transparent to the host, so even 15-year-old legacy systems that speak Ethernet can use the present invention.

It is an object of the invention to encrypt all critical data transmitted inside a network and data sent out of the network to other systems using a secure, intelligent network interface.

It is a further object of the invention to eliminate internal attacks and sniffing.

It is another object of the invention to eliminate the need for expensive leased lines for VPN since all data transmitted over open lines is encrypted.

It is another object of the invention to enable single, centralized systems management of all passwords, network access, and user rights, while providing security on the workstation level.

It is another object of the invention to eliminate the need for separate firewalls, Intrusion Detection Systems (IDS), and PKI.

It is another object of the invention to enable single sign-on, centralized password management, centralized security management, network auditing, intrusion detection (& prevention), web auditing and filtering, network arbitration, virus scanning, security vulnerability scanning, fault tolerance, machine diagnostics, encryption, authentication, firewalling, key management, policy enforcement, and auditing.

It is yet another object of the invention to provide universal translation means enabling any platform to communicate seamlessly (Unix, Windows, Mac, etc.) over the same network.

### BRIEF DESCRIPTION OF THE DRAWINGS

FIGS. 1A and 1B illustrate the single sign-on of the present invention.

FIG. 2 discloses a prior art proxy arrangement.

FIG. 3 illustrates the proxy arrangement of the present invention.

FIG. 4 illustrates the internal architecture for implementing the secure, intelligent network interfaces of the present invention.

FIG. 5 illustrates an example network architecture of the present invention.

FIGS. 6A-6B illustrate the PCI card and stand alone arrangements of the secure, intelligent network interface of the present invention.

FIG. 7 illustrates a hierarchical configuration of secure, intelligent network interface management servers in accordance with the present invention.

FIG. 8A discloses a prior art security arrangement.

FIG. 8B illustrates the security arrangement of the present invention.

### DETAILED DESCRIPTION OF THE INVENTION

The secure, intelligent network interface of present invention provides secure network communication. The secure, intelligent network interface handles all network communication on each node or computer on the network. The secure, intelligent network interface can be built into a network interface card (e.g., a PCI NIC, a PCMCIA NI card, an 802.11 a/b/g card, a BlueTooth card, a Home RF card, HomePNA card, a proprietary NI, etc.) or be a separate box between each NIC and the network. The secure, intelligent network interface encrypts outgoing packets and decrypts incoming packets from the network based on a key managed by a CMC (i.e., central server) on the network.

In a first embodiment, the secure, intelligent network interfaces can provide encryption using a peer-to-peer solution. By implementing the Internet Key Exchange (IKE) protocol, key management is provided by a protocol standard which is used in conjunction with the IPSec standard. IPSec is an IP security feature that provides robust authentication and encryption of IP packets. IPSec can be configured without IKE, but IKE enhances IPSec by providing additional features, flexibility, and ease of configuration for the IPSec standard. IKE is a hybrid protocol which implements the Oakley key exchange and Skeme key exchange inside the Internet Security Association and Key Management Protocol (ISAKMP) framework. (ISAKMP, Oakley, and Skeme are security protocols implemented by IKE.)

Encryption can also be provided by a second method, which proceeds as follows for client authentication (the process can be reversed for server authentication). For a client to initiate a connection with the server, the client's secure, intelligent network interface sends a request to the central management console (CMC) with the identifying information about the connection that the client wishes to send to the server. The information includes, among other things, the protocol, distinguished name, service, and header information. The CMC reviews the connection against a network policy and can decide the following types of information:

a. Deny or Allow the connection

b. Encryption algorithim

c. Authentication required

d. Keys for the connection

e. If the connection should be redirected to another machine

f. If the connection needs to be translated (in which case the appropriate servlets will be supplied—this would include protocol translation, SSO, and fault tolerance requirements).

The CMC then sends the decision including encryption and authentication algroithim(s) (they can be different), key(s), and any translation servlets required to the client interface, which then initiates the connection with the server's intelligent network interface. The server's interface queries the CMC with the connection information just received and encrypted from the client interface. This will include the SPI (Security Paramaters Index, a standard IPSec term) for the connection that uniquely identifies the connection between the client and server interfaces. The CMC repeats the steps to and for the server's interface. In this manner, the client and server are provided with transparent encryption through their respective secure, intelligent network interfaces.

The secure, intelligent network interface can also be configured with applications and scripts to perform protocol translations, single sign-on functions, distinguished-name based firewall functions, proxy functions, fault tolerance functions, and gateway intrusion detection functions, etc.

The secure, intelligent network interface easily implements a single sign-on system because the interface is already filtering and decrypting data, so it is trivial to have it authenticate the sender as well. If the sender is valid, it automatically negotiates with the legacy system behind it and logs the user in directly, without needing to provide a password.

Because the use of secure, intelligent network interfaces changes the way security is administered and deployed across a network, it allows a number of additional security and network features to be deployed within the architecture.

Typical hardware features of the client version of the present invention will include means for network speeds 10/100 Ethernet as well as gigabit Ethernet. The interface should also include processing speed capable of that throughput and speed sufficient for decryption and encryption that will be required, such as an Alchemy Au1500™ processor, from Alchemy Semiconductor, Inc., 7800 Shoal Creek Blvd., Suite 222W, Austin, Tex. 78757.

Memory can include a small amount (i.e., 8-16MB) of updateable flash memory for the OS (such as OpenBSD or Linux®) and 32-64MB of dynamic RAM for running applications and scripts. An input is included for physical identification requirements, whether directly connected to the client machine, such as a serial, USB or parallel port, or implemented as a port, such as a USB port or parallel port, on the secure, intelligent network interface.

Optional hardware features can include an iButton® interface built into the secure, intelligent network interface and various implementation embodiments, such as, but not limited to PCI cards, PCMCIA cards, and Ethernet-boxes, can be used. Additionally, rapid I/O—high bandwidth bus systems, such as HyperTransport™ from AMD® and Arapahoe (3GIO) from Intel®, can also be used.

A server embodiment of the present invention will typically need to handle more throughput and can therefore include an encryption accelerator on an FPGA (field programmable gate array). A gigabit embodiment can also be implemented that is different from either the client or server versions. A relay embodiment of the present invention can be used for connecting to mainframes and other pre-PCI legacy equipment that includes Ethernet. The relay embodiment can be a custom stand-alone box or any COTS (commercial off the shelf) personal computer with a pair of Ethernet ports.

Each node (client, server, mainframe, etc.) should feature: full IP filtering; complete Peer-to-Peer security; optional pass-through for other Ethernet protocols (e.g., netbios); support for Dynamic Host Configuration Protocol (DHCP) from both the network and the machine side; full Firewalling; rules downloaded from server based on either the machine (MAC address) or the user ID; default rules set to “deny all”; filtering based on connection identification information (match current firewall capabilities); filtering based on encryption and authentication options (so if authenticated allow, if encrypted allow, if both allow type options); filtering based on both endpoints; capability to drop anonymous packets; transparent proxies; network address translation (NAT) for one machine; Virtual Private Network (VPN) tunneling and full encryption; Internet Protocol Security (IPSec); support login client and physical login (strong user authentication) mechanisms (built in support for iButton if chosen); transparent authentication and encryption of traffic (based on CMC provided keys.

The system should also allow transparent single sign on to any device using applications or servlets supplied by the CMC to allow user/password to be negotiated automatically. An advantage of the present implementation is that it requires no changes to the server software or the end user software. User/passwords can be stored on the centralized management system and given out securely and on an as needed basis to the clients (thereby providing single point of control). Low-level intervention is modular enough to negotiate on a protocol basis.

The server software of the present invention provides policy administration. Traffic policy can be determined on a per user or per host basis and is distributed on an as needed basis to the individual nodes. The server software can also group users and hosts to make policy management easier. If an iButton is used, host and user entries can be added through the iButton interface.

Server policy administration allows: both endpoints to be specified; the specification of the types of protocols and services allowed; specification of the type of encryption, and authentication required. (i.e., might want to specify both as strong, weak, and none).

With respect to user administration in the present invention, most access is based on users, not IP addresses (this is the expected and optimized behavior). Users are granted and denied privileges on a network-wide basis by the CMC. All passwords and users can be maintained at a single point. User privileges can be revoked at the CMC.

Critical nodes (nodes that are in front of servers and the policy is created based on host) can identify when the client machine goes down and can transparently allow all traffic to roll over to another machine—run by the CMC. Roll over will not, during this phase, be transparent to an individual connection.

The present invention can also be used for monitoring and auditing. For example, all traffic on the network can be logged; all authentication, time, and service information can be saved separately; all errors and security problems (i.e., anonymous connections, bad keys, and suspicious activity) can be security logged; and keys can be recovered to allow monitoring tools to audit records to be kept unencrypted.

The present invention can also be implemented to allow deployment in phases across a network, so initial deployment allows for compartments to be created.

Various new technologies can also be implemented using the present invention. A universal translator for networks can be implemented since secure, intelligent network interfaces sit on the network between communicating machines. Since secure, intelligent network interfaces pass every packet that is transmitted between two machines, the present invention has ultimate control over both the packet headers and the packet content.

Packet headers range from information about the two machines communicating, to information about the encryption, and authentication for that communications channel. All of this information is contained in a hierarchical packet structure that is assembled using the ISO 7 layer protocol stack: ranging from information on the data link layer, to information on the applications running over the network.

Each of the layers can be viewed and monitored for security and auditing purposes. But they can also be changed on the fly to facilitate communication across the network using the architecture of the present invention. On a packet header level the following types of translation of protocols within a single layer of the ISO 7 layer protocol stack are possible.

IP to IPSec—adding encryption and authentication.

IP to IP6 —Changing the packet header format.

Address translation—Changing the network address for the machines communicating.

Port translation—Changing the ports over which the machines believe they are communicating. An example would be to act as a proxy or filter for specified connections.

This type of universal translation can also be done over the application protocols allowing the present invention to transparently provide backwards compatibility or protocol interaction. Some examples of useful application level translation:

SMB to NFS or HFS, allowing two completely different file transfer protocols to interoperate. This allows Windows® and UNIX or Mac OS systems to share files while still using their native protocols.

Lotus Notes R4 to R5, for example, when Lotus upgraded their notes server, older clients were no longer able to access the newer servers. This required that existing computer networks and applications had to be upgraded. On large networks this can mean thousands of machines need to be updated. The present invention can seamlessly convert between the versions, allowing clients to communicate with the new server without having any updates installed. This could also be used to provide Microsoft Net functionality to non-Microsoft OS machines.

The present invention can also use Distinguished Name to provide for “Single Sign On.” The present invention has total control, because of the technology in the universal translator, over all user authentications across a network. The secure, intelligent network interfaces and CMC can use software and/or hardware verification of the user ( i.e., username/password, fingerprint reader, smartcards, iButton devices, etc.) accessing the protected machine. This verification is then used to gain access to further network controls. Therefore, the user need only log into the secure, intelligent network interface on the machine being used and all other authentication requests are intercepted by the secure, intelligent network interface which communicated with the CMC to have the requests transparently answered.

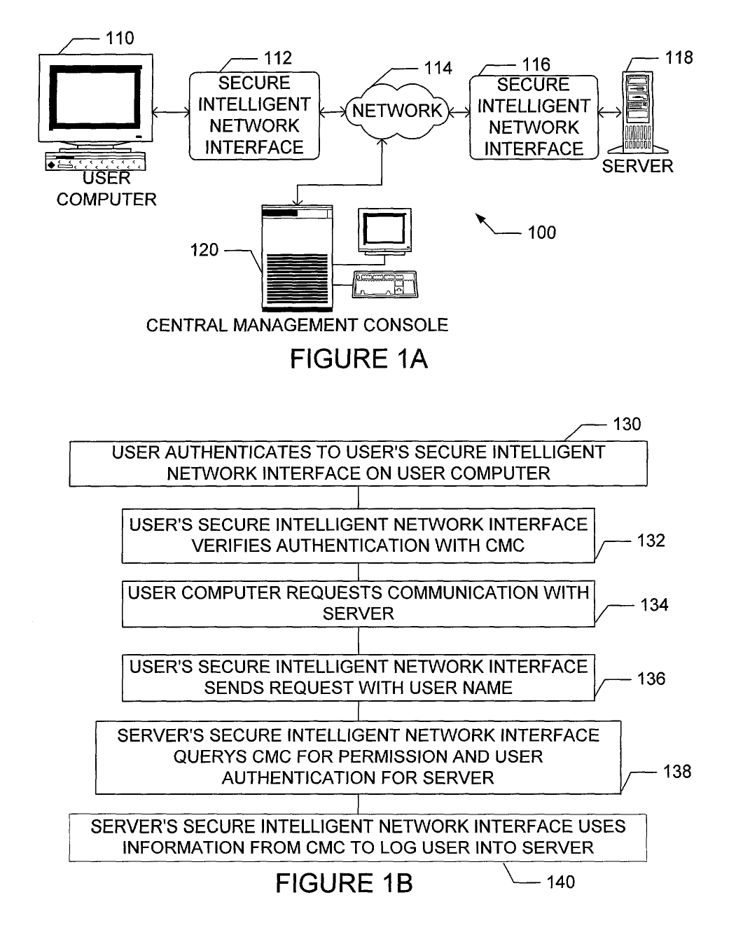

Since the secure, intelligent network interfaces can sit on the line between the network and the protected machine, no changes in the machine, either in the operating system or services, are required for authentication to be achieved. All authentication information is automatically inserted into the communication stream on behalf of the user, assuming that type of connection is allowed, as illustrated in FIG. 1A-B.

In this embodiment, a user authenticates, at step 130, to a secure, intelligent network interface 112 attached to computer 110. Interface 112 then verifies the authentication, at step 132, with CMS 120 over network 114. To allow a user to access the services of server 118, computer 110 requests communication with server 118, at step 134. Interface 112 on computer 110 then sends the request, at step 136, with the users name.

The secure, intelligent network interface 116 of server 118 receives the request over network 114 and queries the CMS 120 for permission and user authentication, at step 138, to allow the user to access the server 118. The CMS 120 provides this information to interface 116, which then uses it to log the user into the server 118, at step 140.

Each secure, intelligent network interface is able to dynamically request and update “servlets” which describe the procedure for authenticating a user to a particular service and operating system combination. This also insures that the secure, intelligent network interfaces can adapt to any protocol or service, allowing networks to have a universal solution to the single sign on problem.

In addition, since all authentication information is stored on a CMC, which is then queried by the individual secure, intelligent network interfaces, the interfaces of the present invention allow an administrator a single point of control over all user access and user authentication information, including, but not limited to, passwords, user names, and any physical methods of identification.

The present invention also allows for the use of a Distinguished-Name Based Firewall. Current firewall technology allows traffic between two networks to be blocked based upon the IP headers. Unfortunately, this information only includes data about machine IP-addresses, service protocol numbers, and types of protocols (icmp, tcp, or udp). It does not include information about the user of that service, or what how that service port is actually being used. The following table lists the common layers in the Internet protocol implementation:

Secure Interface Protocol Stack

| Layer | Name | Example |
|---|---|---|
| 6 | Metadata | Distinguished Name |
| 5 | Content | Email messages, WWW pages |
| 4 | Application | SNMP, FTP, SMTP |
| 3 | Transport | TCP, UDP, ICMP |
| 2 | Network | ARP, IP |
| 1 | Data Link | Ethernet |

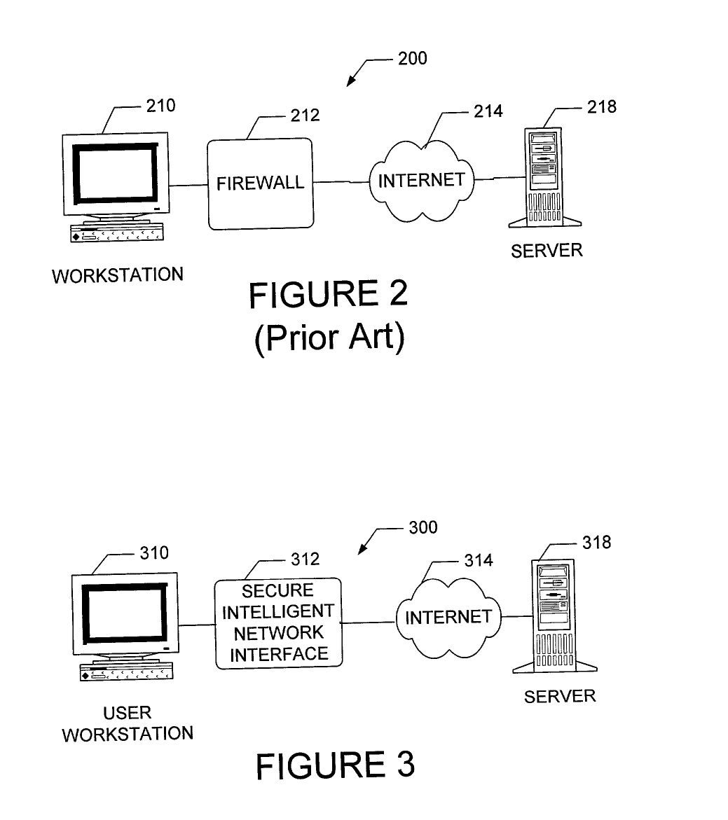

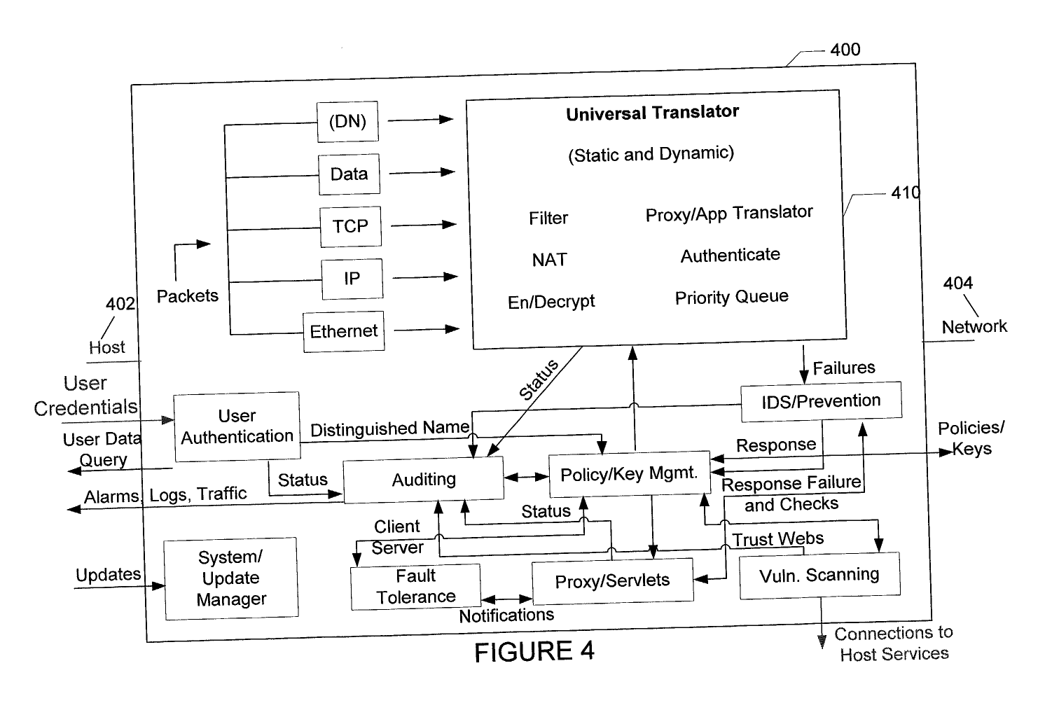

As illustrated in FIG. 2, common firewalls 212 are used to protect workstations 210 when using the Internet 214 to access server 216. However, these firewalls 212 only focus on layers two and three, and some have proxy functionality that deals with a few of the protocols that run at layer four. The present invention, as illustrated in FIG. 3, places a secure, intelligent network interface 312 between the user workstation 310 and the Internet 314 and server 318 so as to provide firewall features across all layers of the protocol stack, including filtering based upon Distinguished Name (or the authenticated universally unique username).

The present invention can provide these features on a peer-to-peer network, across a WAN, or in a local environment. Some of the functionality is tied to the firewall through proxies.

Proxies, in the present invention, can include Dynamically Distributable Servlet/Proxies. Each proxy on the secure, intelligent network interface is dynamic in that it may be changed at any time by the CMC. This allows the secure, intelligent network interface to respond to new types of attacks, new types of protocols, or policy changes in real time and without any physical contact on the part of the systems administrators. Many current proxies are so tightly integrated into the firewall that changing a proxy means that the entire firewall needs to be updated.

Proxies, in the present invention, can also use the same IP-address. Current proxies work by accepting the outgoing request, initiating a new request, and passing through allowed data. This process inherently changes the requesting computers IP-address since the proxy server is initiating the request, as illustrated in FIG. 2. Since the present invention is much more tightly integrated into the IP stream, as illustrated in FIG. 3, it can proxy requests while still allowing the requesting computers IP-address and original port through, if desired. This can provide transparent proxying to both ends.

The present invention also can provide fault tolerance. Internet web servers and routers have become an integral part of business today and as such companies require that they be up every hour of every day. Unfortunately computers need regular care and periodically run into hardware or software errors which cause them to come down from time to time. Fault tolerance allows the functions that the computer was performing to be moved to a separate backup system. A number of systems currently exist which when a machine goes down roll over processing to a secondary machine by means of software integration or hardware connections between the two machines.

The present invention, however, can provide non-host integrated fault tolerance. Fault tolerance is implemented between machines without needing to install any software or hardware on the critical machines. As illustrated in FIG. 9, by monitoring the server 910 from its network connection to ensure that it is still up or not, the secure, intelligent network interface 912 can identify when functionality needs to be moved to the backup 920. Then, since the present invention controls all data going into and out of that server 910, it can reroute traffic to the secondary server 920 through interface 916 without any changes taking place on either server. Although illustrated with respect to servers, it can be implemented on any machine, be it a workstation, mainframe, etc., that includes the interface of the present invention.

In addition, since the secure, intelligent network interfaces can maintain state for existing connections, they can not only move new connections over to a secondary machine, but the present invention can reestablish existing connections and input all the state needed to regain the exact connection that would have otherwise been lost.

Prior art network Intrusion Detection Systems (IDS) use sniffing (network promiscuous monitoring) to watch the traffic that is traveling over the network. Unfortunately, this limits the types of responses to attacks that are possible. It also limits to locations and types of networks that can be monitored. The present invention, because of its location on the network, is able to take a gateway approach.

Gateway IDS of the present invention allows secure, intelligent network interfaces to not only monitor the traffic going over the network, but also to stop, filter, and reroute any traffic that is identified as an attack. The present invention does not have the problem of “losing” traffic because the network is too busy because all traffic has to pass through secure, intelligent network interfaces.

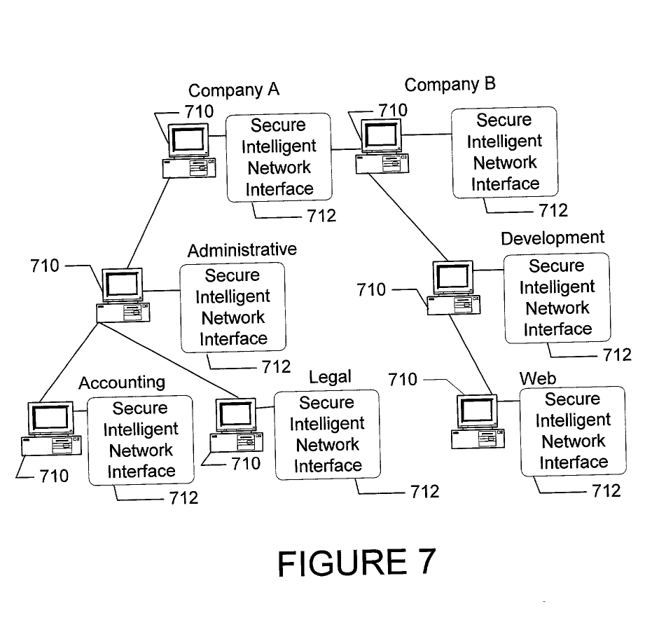

In one preferred embodiment, the secure, intelligent network interface of the present invention is a general-purpose computer that arbitrates network functions between a host and a network. This invention can be placed either on a network interface card (NIC), as illustrated in FIG. 6A, or on a stand-alone device, as illustrated in FIG. 6B, which sits between the network and the host. The primary purpose of this device is to provide security to the network but the invention can also provide a multitude of non-security functions as well such as protocol translation, traffic priority queueing, and fault tolerance.

In the NIC embodiment illustrated in FIG. 6A, the PCI card 612 includes the standard network adapter 658, but further includes its own processor 650, flash memory 652, DRAM 654, serial authentication input 656 and, optionally, a FPGA 660 to handle hardware encryption. The standalone version or relay embodiment, illustrated in FIG. 6B, can use a standard PC 622 with dual NICs 624 (i.e., for host) and 626 (i.e., to the network). In this way, it can utilize the CPU and memory of the PC 622 to provide the functions of the present invention when a host machine cannot accept a PCI card or other network interface version of the present invention.

Current network interface devices are extremely limited in capability. Their primary purpose is to simply relay data, verbatim, between the host and the network. More recently, network interfaces have become available which can provide simple SSL decryption to accelerate web servers or stamp “Type of Service” qualifiers on packets.

The present invention is a significant advancement on the state of the art by providing general-purpose network arbitration functionality onto a network interface. This arbitration can provide peer-to-peer encryption and authentication, firewalling, single sign-on, and centrally updated security patches.

Because the invention arbitrates all data between the host and the network, it is capable of providing it's functionality completely transparently to the host. The host sends unencrypted data to the secure, intelligent network interface, which automatically performs security processing, and optionally encrypts and authenticates the data. When secure data is received, the invention automatically performs security processing, decrypts and authenticates the data. If the data is deemed safe and authentic, the secure, intelligent network interface sends the decrypted data onto the host. The host therefore requires no changes to services or applications in order to benefit from security.

Because the invention arbitrates all data between the host and the network, it provides a universal mechanism for protecting against security vulnerabilities. When a new vulnerability is discovered, the current state of the art requires a system administrator to apply patches to each of his computer systems. This may require updating of thousands of systems, with dozens of different patches (depending upon the platform being patched). The present invention significantly improves upon the state of the art by allowing a single patch to be applied instantaneously to all platforms through a centralized management system (CMC). The patch need only instruct the secure, intelligent network interfaces how to block a particular attack from occurring. The attack is then blocked on every platform, regardless of the vulnerability of the underlying system.

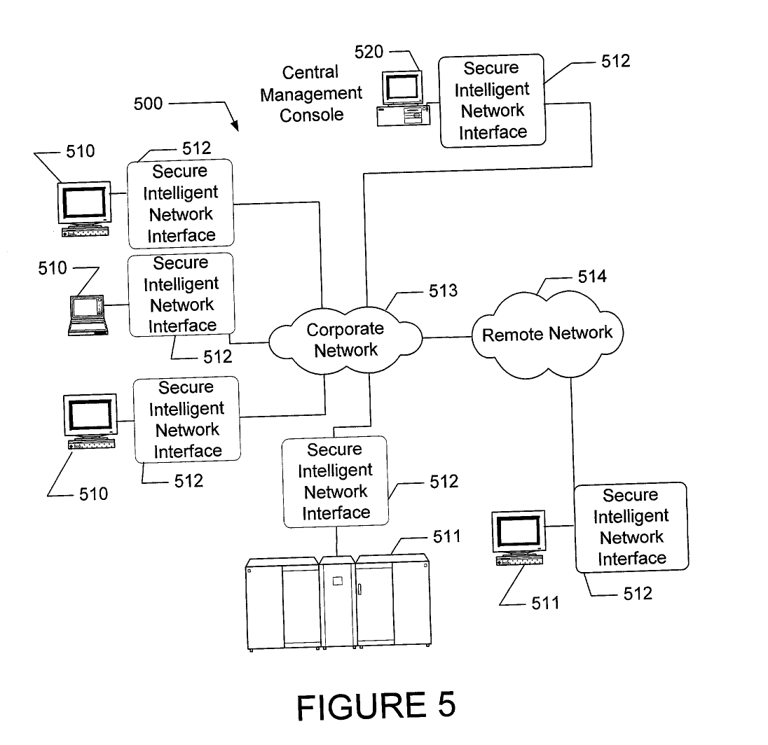

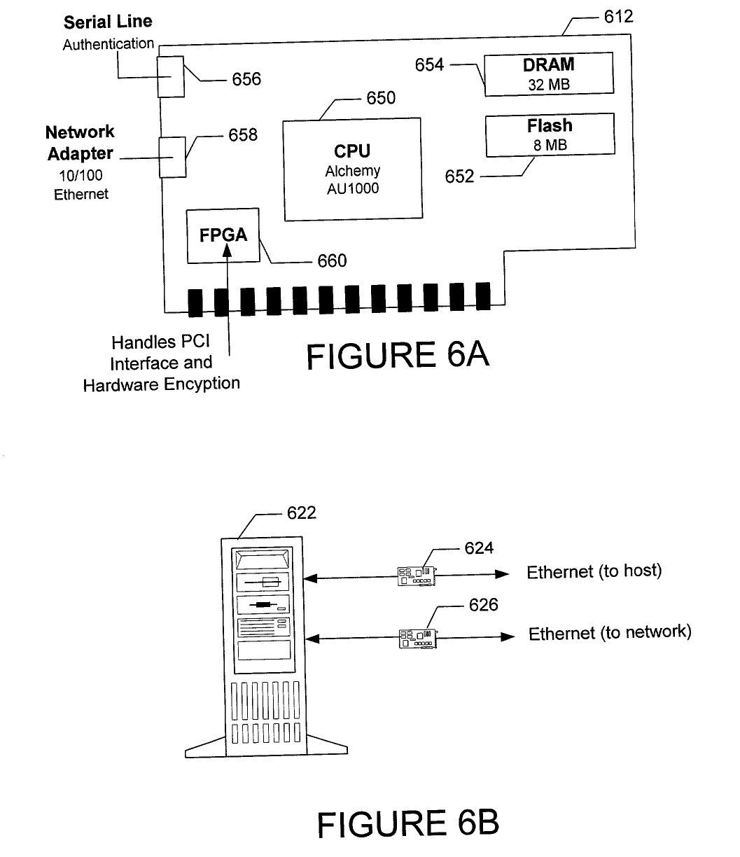

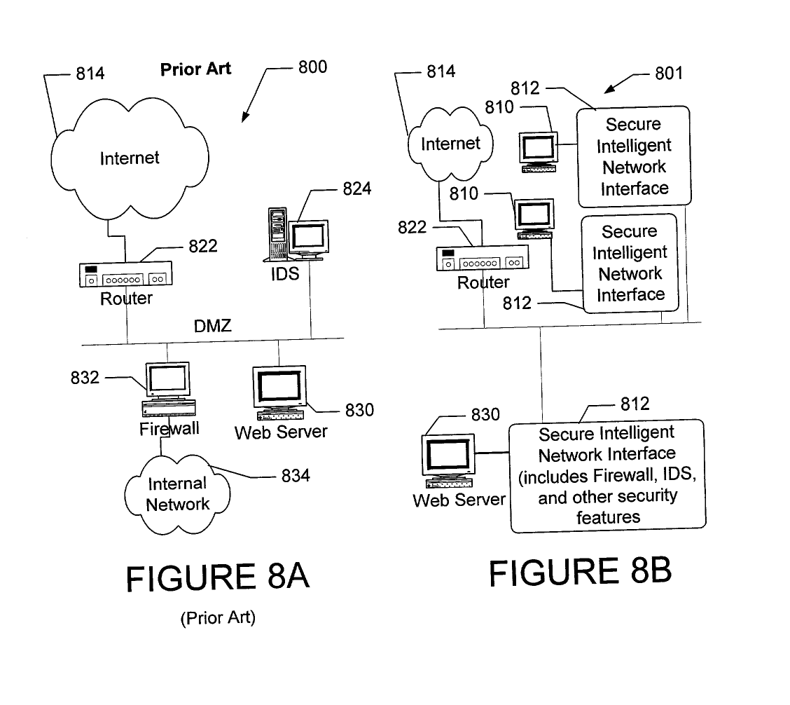

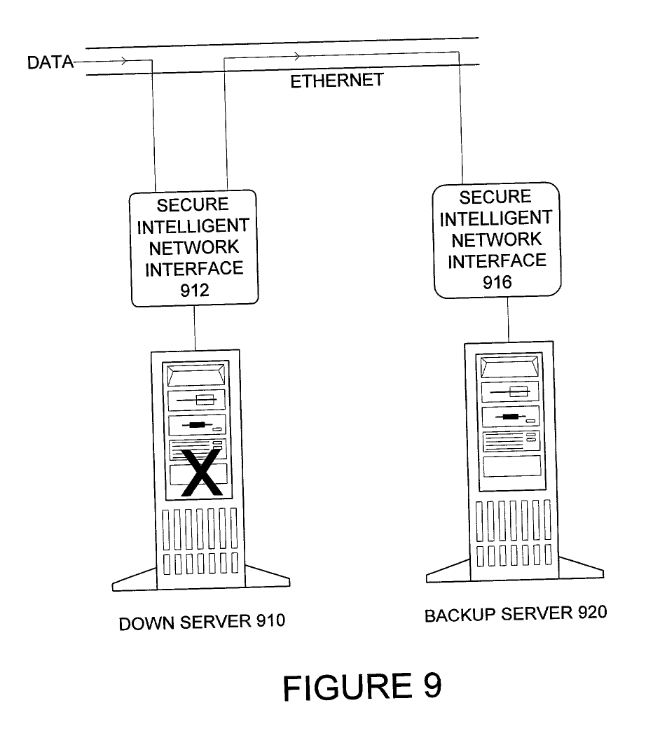

The internal architecture of the present invention is illustrated in FIG. 4 and can be described at a high level as a “Security Agent Architecture.” The present invention 400 is placed between a host 402 and a network 404 and includes a universal translator 410. When configured as shown in FIG. 8B, the present invention provides each host with a set of security agents, comprising such functionality as Intrusion Detection, Security Vulnerability Scanning, Encryption, Authentication, Firewalling, Single Sign-on, Key Management, Policy Enforcement, and Auditing. These agents are centrally managed through a hierarchical set of “Management Servers” as illustrated in FIGS. 5 and 7.

In FIG. 5, the system 500 includes a plurality of user computers 510 having secure, intelligent network interfaces 512 attached to a corporate network 513. All the other machines on the corporate network, such as mainframe 511, also have interfaces, which in the case of mainframe 511 will be a relay interface 512. One of these is a central management console (CMC) 520 that is used for managing all of the interfaces 512. If the corporate network 513 is connected to a remote network 514, such as the Internet, a remote user computer 511 can securely access the corporate network 513 through a secure, intelligent network interface 512 connected between the remote computer 511 and the remote network 514. Although FIG. 5, discloses only a single CMC 520, numerous CMCs 710 can be deployed in a hierarchical arrangement, as illustrated in FIG. 7, to allow modular and compartmentalized deployment.

The current state of the art, as shown in FIG. 8A, places security functionality on centralized servers 824, 832, etc. The drawback to such an architecture is that the security functions are only provided at the location of the server. For example, a firewall 832 placed between the Internet 814 and the Intranet 834 only blocks certain attacks coming from intruders external to the network. Since 70% of all security breeches are by insiders, a firewall 832 in such a configuration is virtually ineffective at protecting the network 834.

The present invention distributes these functions on interfaces 812, as illustrated in FIG. 8B, to every node 810, 830 on the network. In addition to making security functions universal, the invention makes them centrally manageable. A network administer can specify policies, update agents, patch vulnerabilities, track usage, and manage users all from a central management server.

Because the invention combines multiple security functions into a single device through an overlaying agent architecture, the agents can interact with one another providing extremely powerful security features. For example, upon detecting an attack, the Intrusion Detection agent 1) Directs the Auditing agent to record all data related to the attack, 2) Notifies the Firewall agent to block any further communications from the attacker, 3) Triggers the Vulnerability Scanning agent to look for any other hosts which might be successfully attacked. The autonomous agent collaboration enabled by the invention's security agent architecture is vastly superior to the current state of the art where individual security functions never communicate.

In a preferred embodiment, the CMC contains a set of code fragments, herein called “servlets.” They are not complete programs, but rather plug-in modules that modify the behavior of pre-existing proxies. In order to perform Single Sign-on (SSO), for example, the proxy needs to know how to negotiate with the underlying protocol that it is trying to sign-on to. Servlets contain the knowledge of that “language”.

Whenever an SSO connection occurs, the proxy must know both how to speak the language and what to say. The CMC provides the script, which the servlet uses to negotiate the sign-on.

The invention maintains a cache of servlets that are regularly checked against the master repository on the CMC. If a superior way of negotiating with a protocol is available (or if the host protected by the invention is upgraded), a new servlet is automatically downloaded and used.

On a low level, servlets contain a single function, named “entry( )”, which performs all in-stream translation. For example, in the case of the telnet service, entryo will see the server send the message “login:” Entry( ) will recognize that as a prompt for the username of the authenticated client, and not pass that message onto the client. It will instead send the username. The server will then send the message “Password:” Entry( ) will again recognize this as a prompt for the password of the authenticated client, and not pass that message on. It will instead send the password. If the login is successful, Entry( ) will relinquish control of the session so that it becomes a simple pass-through—all data sent by the server goes to the client and vice-versa. If the login is not successful, Entry( ) prompts the client for the username and password, which it then sends to the CMC for storage, and repeats the procedure until the user is logged in, or gives up. Using this technique, the user can update their password on the server without the invention needing cumbersome synchronization processes on each server.

The servlets can also deny access to a particular username or authenticated client. For example, if “Bob” gets fired, the servlet will be notified by the script that no access should be allowed. “Bob” can never login to the server, under any conditions, even if he has guessed someone else's password.

Scripts are formatted as simple set of “variable=value” lines. For example:

X=4

Y=7

User=bob

Password=hellobob

The specific descriptions of the invention above mention specific technical details which are not considered limiting, i.e., which should be understand as inclusive of others, rather than exclusive. For example:

A processor other than the Au1000 may be used, such as a StrongARM, SH-4, x86, etc.

10/100Mb Ethernet is mentioned, but the invention could also use Gigabit Ethernet, FDDI, Token Ring, etc. In addition, for portable applications, it may be desirable to provide a telephone interface (i.e., hook it right up to the phone line), and for broadband, a T3, T1, etc.

Encryption may be done in hardware instead of software.

The iButton authentication device from Dallas Semiconductors is only one form of authentication, and the invention may also use usernames/passwords, biometrics, smart cards, or any number of other means.

The present invention can apply equally to both IP and IPv6.

The invention may also use a PCMCIA form factor (for laptops) in addition to a PCI card version, HyperTransport or Arapahoe version, and standalone version.

The servlets can be programs, objects, XML, or readable scripts.

The present invention incorporating the secure, intelligent network interface is totally scalable and transparent to the end-user, providing a holistic and pervasive solution to some of the most pressing needs and challenges faced by companies looking to secure their data from both internal and external threats. In a preferred embodiment, the invention employs the AES encryption algorithm as a default for security reasons, but also supports the relatively less secure DES encryption algorithm required by the IPSec RFC.

We claim:

1. A method for providing secure network communication, comprising:
providing an intelligent network interface between a network and each device on the network;
encrypting and decrypting critical data transmissions over the network using said intelligent network interfaces; and
centrally managing keys and algorithms used by said intelligent network interfaces for encrypting and decrypting critical data transmissions over the network with a central management console.

2. The method of claim [c1], further comprising each intelligent network interface providing protocol translation based on servlets provided by said CMC.

3. The method of claim [c3], wherein said protocol translation is selected from the any two protocols within a single layer of an ISO 7 layer protocol stack.

4. The method of claim [c2], further comprising said CMC dynamically distributing proxy servlets to intelligent network interfaces based on distinguished name.

5. The method of claim [c2], further comprising said CMC dynamically distributing servlets to intelligent network interfaces based on distinguished name, said servlets selected from the group consisting of single sign-on servlets, distinguished name firewall servlets, auditing servlets, policy enforcement servlets, and web-filtering servlets.

6. The method of claim [c2], further comprising said CMC dynamically distributing servlets to intelligent network interfaces based on device, said servlets selected from the group consisting of fault tolerance automatic rollover servlets, gateway intrusion detection servlets, multi-level firewall servlets, machine diagnostics servlets, virus scanning servlets, and security patching servlets.

7. The method of claim [c1], further comprising:
a first intelligent network interface associated with a first client sending a request to the central management console (CMC) with the identifying information about a connection that the first client wishes to send to a second client, said information including protocol, distinguished name, service, and header information;
said CMC reviewing said connection against a network policy and determining denial or allowance of said connection and, upon allowance, further determining encryption algorithim, authentication required, keys for the connection, if the connection should be redirected to another device, and if the connection needs to be translated;
said CMC sending a connection determination, including encryption and authentication algroithim(s), key(s), and any translation servlets required to said first intelligent network interface;
said first intelligent network interface initiating said connection with a second intelligent network interface associated with said second client by sending encrypted connection information;
said second intelligent network interface querying said CMC with said encrypted connection information received from said first intelligent network interface, including a Security Paramaters Index (SPI) for said connection that uniquely identifies said connection between said first and second intelligent network interfaces.

8. The method of claim [c2], wherein said authentication is selected from the group consisting of username/password, biometric inputs, smart cards, tokens, and combinations thereof.

9. The method of claim [c1], further comprising providing a plurality of CMCs on said network in a hierarchical configuration.

10. The method for providing distinguished name single sign-on for users of host devices on a network comprising:
providing an intelligent network interface between a network and each device on the network;
providing a central management console (CMC) on said network;
a user providing a distinguished name and authentication to a first intelligent network interface attached to the user's host device;
the first intelligent network interface verifying the user's authentication with the CMC such that when said user requests services from a second device:
the first intelligent network interface requests communication with said second device based on distinguished name;
a second intelligent network interface associated with said second device queries the CMC for permission and user authentication for the second device based on distinguished name; and
the CMC provides user authentication information based on distinguished name to said second intelligent network interface to allow said second intelligent network interface to log the user into the second device.

11. A system for providing secure network communication, comprising:
a network;
a plurality of host devices connected to said network;
an intelligent network interface between each host device and said network;
means on each intelligent network interface for encrypting and decrypting critical data transmissions over the network; and
at least one central management console for providing keys and algorithms used by said intelligent network interfaces for encrypting and decrypting critical data transmissions over the network.

12. The system of claim [c11], wherein each intelligent network interface further comprises:
a CPU;
memory;
an I/O interface for the network; and
a second I/O interface for the host device.

13. The system of claim [c12], wherein each intelligent network interface is implemented in a form selected from the group consisting of PCI cards, PCMCIA cards, rapid I/O-high bandwidth cards, and standalone devices.

14. The system of claim [c12], wherein each intelligent network interface is implemented in a form selected from the group consisting of PCI NIC cards, PCMCIA NIC cards, rapid I/O-high bandwidth NIC cards, and standalone devices with an Ethernet second I/O interface.

15. The system of claim [c12], wherein each intelligent network interface further comprises a serial line authentication port.

16. The system of claim [c15], wherein said serial line authentication port is a USB port.

17. The system of claim [c12], wherein said intelligent network interface further comprises parallel port authentication port.

18. The system of claim [c12], wherein said memory consists of flash memory for storing an OS and dynamic memory for applications.

19. The system of claim [c12], wherein said memory consists of a hard drive for storing an OS and applications and random access memory for running said OS and applications.

20. The system of claim [c12], wherein said intelligent network interfaces have an OS that is distinct from said host devices.

21. The system of claim [c12], further comprising:
an encryption accelerator on a field programmable gate array (FPGA) on said intelligent network interface.

22. The system of claim [c11], further comprising:
a set of dynamically distributable code fragments stored on said CMC for distribution to said intelligent network interfaces; and
means on said intelligent network interfaces for using said code fragments to provide functions selected from the group consisting of: authentication, protocol translations, single sign-on, multi-level firewalling, distinguished-name based firewalling, centralized user management, machine diagnostics, proxying, fault tolerance, centralized patching, web filtering, virus scanning, auditing, and gateway intrusion detection.

23. A system for providing secure network communication, comprising:
a network;
a plurality of host devices connected to said network;
an intelligent network interface between each host device and said network;
at least one central management console for dynamically distributing security agent servlets to said intelligent network interfaces; and
means on each intelligent network interface for running said security agent servlets.

24. The system of claim [c23], wherein each intelligent network interface further comprises:
a CPU;
memory;
an I/O interface for the network; and
a second I/O interface for the host device.

25. The system of claim [c24], wherein each intelligent network interface is implemented in a form selected from the group consisting of PCI cards, PCMCIA cards, rapid I/O—high bandwidth cards, and standalone devices.

26. The system of claim [c24], wherein each intelligent network interface is implemented in a form selected from the group consisting of PCI NIC cards, PCMCIA NIC cards, rapid I/O—high bandwidth NIC cards, and standalone devices with an Ethernet second I/O interface.

27. The system of claim [c24], wherein each intelligent network interface further comprises a serial line authentication port.

28. The system of claim [c27], wherein said serial line authentication port is a USB port.

29. The system of claim [c24], wherein said intelligent network interface further comprises a parallel port authentication port.

30. The system of claim [c24], wherein said memory consists of flash memory for storing an OS and dynamic memory for applications.

31. The system of claim [c24], wherein said memory consists of a hard drive for storing an OS and applications and random access memory for running said OS and applications.

32. The system of claim [c24], wherein said intelligent network interfaces have an OS that is distinct from said host devices.

33. The system of claim [c23], wherein said dynamically distributed security agent servlets include means to provide functions selected from the group consisting of: encryption, authentication, protocol translations, single sign-on, multi-level firewalling, distinguished-name based firewalling, centralized user management, machine diagnostics, proxying, fault tolerance, centralized patching, web filtering, virus scanning, auditing, and gateway intrusion detection.

34. The system of claim [c33], further comprising an encryption accelerator on a field programmable gate array (FPGA) on said intelligent network interface.

35. A method for firewalling based on distinguished name for users of host devices on a network comprising:
providing an intelligent network interface between a network and each device on the network;
providing a central management console (CMC) on said network;
a user providing a distinguished name and authentication to a first intelligent network interface attached to the user's host device;
the first intelligent network interface verifying the user's authentication with the CMC; and
the CMC dynamically distributing a firewall servlet to said intelligent network interface based on said distinguished name.

36. A method of providing non-host integrated fault tolerance for hosts on a network, comprising:
providing an intelligent network interface between a network and each host on the network;
providing a central management console (CMC) on said network;
said CMC dynamically distributing fault tolerance servlets to said hosts such that, upon a failure of a first host, a first intelligent network interface between said network and said first host redirects packets to a second host on said network without any intervention from said first or second host.
